(19) United States
(12) Patent Application Publication
(10) Pub. No.: US 2013/0187931 A1
(43) Pub. Date: Jul. 25, 2013

(54) SYSTEM AND METHOD FOR MULTIPLE NATIVE SOFTWARE APPLICATIONS USER INTERFACE COMPOSITION

(71) Applicants: Tao Zhao, Shanghai (CN); Brett Wang, Shanghai (CN); John Weast, Portland, OR (US)

(72) Inventors: Tao Zhao, Shanghai (CN); Brett Wang, Shanghai (CN); John Weast, Portland, OR (US)

(21) Appl. No.: 13/000,356

(22) PCT Filed: Oct. 5, 2010
(86) PCT No.: PCT/CN2010/001548

§ 371 Date: Dec. 20, 2010

(51) Int. Cl. G06F 9/30

(52) U.S. Cl. CPC G06F 9/3004
USPC 345/501

(57) ABSTRACT

In an environment with multiple graphics software application framework, a rending application programming interface (API) agent is provided in a rendering API library. The rendering API agent is to find surface information on memory surfaces corresponding to rendering surfaces of the rendering API library and relationship information between the memory surfaces and a process of the redering API application. The rendering API agent is to communicate with a global scene graph library (GSGL) to send the surface information and the relationship information to the GSGL. Binding may be used to transform the memory surfaces to desired rendering API surfaces based on the surface information in GSGL. A user experience application is to manipulate the translated rendering API surfaces to create user experience.

### BACKGROUND

Various graphics software developing applications may be utilized by different digital/electronic systems to render graphical scenes. For example, multiple graphics applications may run in the same system. In the multiple software application framework environment, multiple native application user interfaces (UIs) may need to be taken as input and be composed to create designated user experience. However, the multiple graphics application may be written using different rendering application programming interfaces (APIs) such as Direct Frame Buffer (DirectFB), Open Graphics Library for Embedded System (OpenGL ES), Simple DirectMedia Layer (SDL) or the like. Gathering all the UIs from different graphics applications and doing composition may involve memory copying or software application modifying.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a schematic diagram of a software environment according to an embodiment of the invention.

FIGS. 2A and 2B is a flow chart of a method in accordance with some embodiments of the invention.

FIG. 3 is a schematic diagram of an embodiment of a platform in accordance with some embodiments of the invention.

FIG. 4 is a flow chart of a method in accordance with an embodiment of the invention.

### DETAILED DESCRIPTION

The following description describes a usage model to utilize unified memory architecture in a system-on-a-chip (SoC). The implementation of the techniques is not restricted in computing systems; it may be used by any execution environments for similar purposes, such as, for example, any other digital/electronic device or consumer electronic (CE) devices. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. However, the invention may be practiced without such specific details. In other instances, control structures and full software instruction sequences have not been shown in detail in order not to obscure the invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

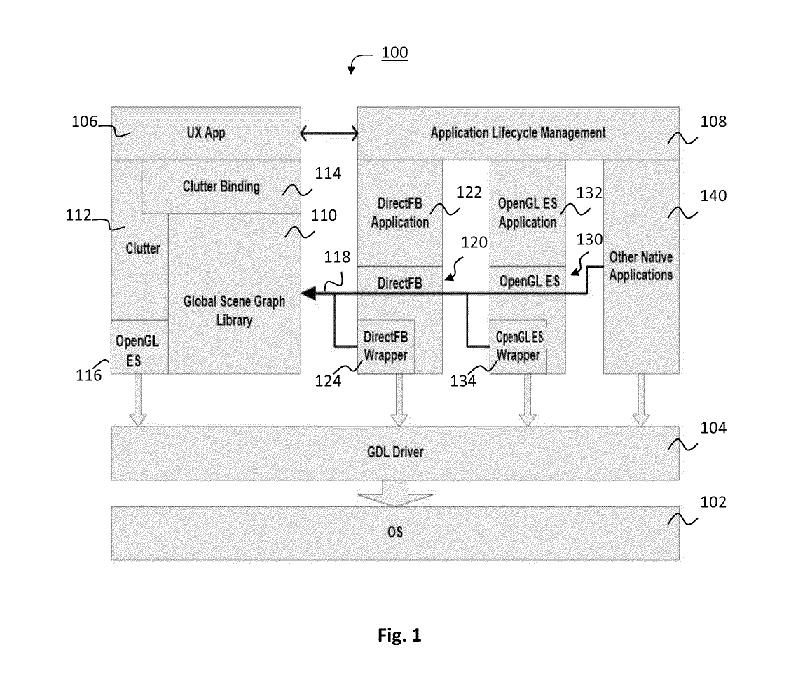

FIG. 1 is a schematic diagram of an environment 100 according to an exemplary embodiment of the invention. In an embodiment, the environment 100 may be implemented on a consumer electronics SoC or any other system. The environment 100 may comprise an operating system (OS) 102 that may be stored in a memory (not shown). In an embodiment, OS 102 may comprise, for example, Linux, Mac OS X, FreeBSD, Microsoft Windows or any other OS. OS 102 may be interfaced to graphics device library (GDL) driver 104. In an embodiment, GDL driver 104 may comprise rendering application or programs that may be executed by hardware of the SoC. In another embodiment, other rendering graphics driver may be utilized.

Referring to FIG. 1, in an embodiment, one or more rendering application programming interface (API) libraries or engines 120, 130 or 140 may comprise software application or program that may comprise one or more rendering functions and/or may communicate with other software. Examples of the rendering API libraries may comprise DirectFB library 120, OpenGL ES library 130 or any other API library. In an embodiment, DirectFB library 120 may comprise DirectFB application 122. OpenGL ES library 130 may comprise OpenGL ES application 132. Reference numerical 140 may represent other rendering API libraries such as SDL or the like. The one or more rendering API libraries may run under an application lifecycle management module 108 that may manage customer applications such as 122, 132 or 140 installed in the environment.

Referring to FIG. 1, the environment 100 may further comprise user experience (UX) application 106 that may be a rendering service software application or a UI manipulation software application. In an embodiment, UX application 106 may communicate with the application lifestyle management module 108 to initiate a customer application 122, 132 or 140 to support one or more graphics capabilities. UX application 106 is visible to a user and may be manipulated by the user directly. In an embodiment, the environment 100 may comprise one or more underlying libraries under UX application 106. In an embodiment, the one or more underlying libraries may comprise a first-level underlying libraries such as Clutter library 112 and Clutter Binding library 114 that may be directly under UX application 106. In another embodiment, the one or more underlying libraries may further comprise a second-level underlying libraries such as OpenGL ES library 116 under Clutter library 112 and Global Scene Graph Library (GSGL) 110 that is under Clutter Binding library 114. In an embodiment, Clutter library 112 may be a graphics library that may comprise Clutter applications to create hardware-accelerated user interfaces.

Although FIG. 1 illustrates the environment 100 may comprise Clutter library 112, Clutter Binding library 114, OpenGL ES API library 116, in some embodiments, UX application 106 may be executed by relying on other underlying libraries. In another embodiment, a different number of levels of libraries or engines may be utilized to support the execution of UX application 106.

Referring to FIG. 1, in an embodiment, each rendering API library 120, 130 or 140 may be provided with a rendering API agent. Examples of the rendering API agents may comprise DirectFB Wrapper 124 for DirectFB API library 120, OpenGL ES Wrapper 134 for OpenGL ES API library 130 or other rendering API agents (not shown) in other native applications 140. In an embodiment, the rendering API agent 124 or 134 may be executed to change an output of the corresponding rendering API library that is displayed on a screen of a display device (not shown) to off screen. In another embodiment, the rendering API agent 120 or 130 may send out surface information on all the underlying memory surfaces (e.g., all the off-screen memory surfaces) that correspond to original rendering API surfaces, and relationship information between the underlying memory surfaces and the corresponding process of corresponding rendering API application to GSGL 110. In an embodiment, the surface information may comprise a description on a memory surface, such as the size, the format, the ID of the memory surfaces. In an embodiment, a process may have its own context. In an embodiment, the relationship information may have a tree or graph structure or any other structure. In an embodiment, inter-process communication (IPC) 118 may be utilized for the rendering API agents to send the surface information and relationship information, e.g., via Desktop Bus (Dbus); however, other communication methods for software may be utilized.

In an embodiment, the GSGL 110 may comprise surface information management module or function to host the surface information on the underlying memory surfaces and the relationship information that are provided by the rendering API agents. Clutter Binding library 114 may be Clutter based binding library that may use the surface information in GSGL 110 to transform or translate the underlying memory surfaces to the form of Clutter recognized surface structure, which is called ClutterActor. In another embodiment, the translated underlying memory surfaces may be recognizable by the UX application. In an embodiment, other binding libraries such as OpenGL ES or DirectFB based binding libraries or translation software may be utilized based on what underlying library the UX application 106 uses. In an embodiment, GSGL 110 may further record surface information on the underlying memory surfaces from the applications of Clutter library 112 or OpenGL ES API library 116. In another embodiment, GSGL 110 may provide an interface to export the surface information on the underlying memory surfaces in the GSGL 110 to the UX application 106. In another embodiment, UX software application 106 may access the surface information recorded in GSGL 110 and the surface information may be used by the Binding Library to translate the underlying memory surfaces into the form of Clutter recognizable surface structure. UX software application 106 may manipulate the translated underlying memory surfaces on an UI of UX software application 106 to create user experience. While FIG. 1 illustrates GDL driver 104, in some embodiments, any other graphics engine may be utilized to communicate with hardware such as processor or access memory.

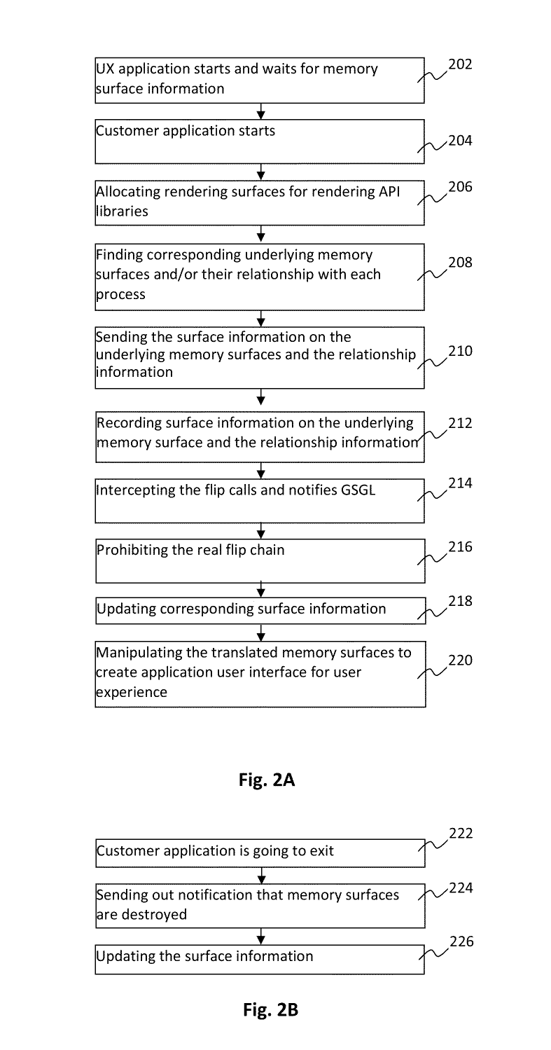

FIGS. 2A and 2B are flow charts showing a method according to an embodiment of the invention. Referring to FIGS. 1 and 2A, in block 202, UX application 206 starts. In an embodiment, the UX application 206 may wait for memory surface information after starting. In block 204, one or more customer software applications such as applications 122, 132 and 140 start. In an embodiment, the UX application 206 may request the application lifestyle management module 108 for the start of the customer application. In block 206, the customer software application may allocate rendering surfaces from rendering API libraries 120, 130 and/or 140. In an embodiment, a rendering surface may be a DirectFB surface or a OpenGL surface. In block 208, rendering API agents such as 124 and 134 in the rendering API libraries may find underlying memory surfaces that correspond to the rendering surfaces. In another embodiment, the rendering API agents may further find relationship information between the underlying memory surfaces and a corresponding process of the rendering API applications. In block 210, the rendering API agents may record the surfaces information on the underlying memory surfaces and the relationship information and send the relationship information and the surface information to GSGL 110 such as the surface information management module. The surface information management module may record the relationship information and surface information (block 212) received from the rendering API agents. In an embodiment, a memory surface may be an underlying memory surface or GDL surface that may be a block of GDL memory (or display memory). The underlying memory surface of a rendering API application may be recorded by a corresponding rendering API library in a block of GDL memory or display memory.

In block 214, in response to one or more flip ( ) calls, e.g., from the customer applications 122, 132 and/or 140, the corresponding rendering API agents 124 or 134 may intercept the flip ( ) calls and notify the flip ( ) calls to GSGL 110. In block 216, the rendering API agents 124 or 134 may prohibit the real flip chain of the corresponding rendering API applications to change the on screen output of the rendering API applications to off screen output. In block 218, GSGL 110 such as the surface information management module may For example, GSGL 110 may update the recorded surface information according to the flip chain of the flip ( ) call. In block 220, UX application 106 may manipulate the translated memory surfaces that are obtained via Binding library based on the surface information in GSGL 110 to create user experience.

Referring to FIG. 2B, in an embodiment, in block 222, the customer application is going to exit. In block 224, the rendering API agents may notify the surface information management module in GSGL 110 that the memory surfaces are to be destroyed. In block 226, GSGL 110 such as the surface information management module may update the surface information in GSGL 110. In one embodiment, GSGL 110 may remove the surface information on the memory surfaces that are to be destroyed and corresponding relationship information.

While the method of FIGS. 2A and 2B are illustrated to comprise a sequence of processes, the method in some embodiments may perform illustrated processes in a different order. In some embodiments, the sequences of processes may be performed together with other processes (not shown).

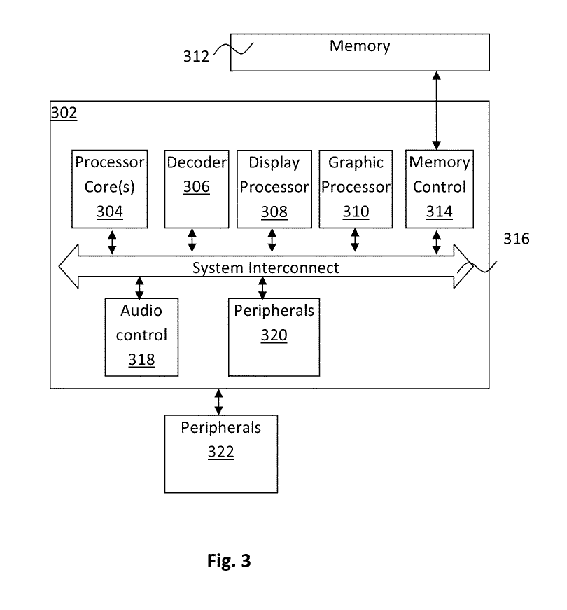

FIG. 3 illustrates an embodiment of a platform 300 which implements the principles of the present invention. One embodiment of the platform 300 may comprise a SoC based on Intel architecture (IA) for consumer electronics devices. It will be readily appreciated by one of skill in the art that the embodiments described herein can be used with alternative processing systems without departure from the scope of the invention.

In an embodiment, computing system platform 300 may comprise a processor 302 that may be a SoC. The processor 302 may comprise one or more processor cores 304. The processor cores 304 may comprise any type of processors capable of executing software and/or process data signals. In an embodiment, the processor cores 304 may comprise a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor such as a microprocessor, digital signal processor or microcontroller. Processor cores 304 may also be suitable for manufacture in one or more process technologies and by being represented on a machine readable media in sufficient detail, may be suitable to facilitate said manufacture.

The processor 302 may comprise a decoder 306. Decoder 306 may be used for decoding instructions received by, e.g., display processor core 308 and/or graphics processor core 310, into control signals and/or microcode entry points. In an embodiment, decoder 306 is a video decoder. In response to these control signals and/or microcode entry points, display processor core 308 and/or graphics processor core 310 may perform appropriate operations. Processing core 304 may be coupled with system interconnect 316 for communicating with various other system devices, which may include but are not limited to, for example, display processor core 308 and/or graphics processor core 310, memory control 314, decoder 306, audio control 318 or peripherals 320 such as unified serial bus (USB) host port, Peripheral Component Interconnect (PCI) Express port, Serial Peripheral Interface (SPI) interface, expansion bus, or other peripherals. In another embodiment, the memory control 314 may be directly coupled to the decoder 306, the display processor core 308 and/or graphics processor core 310; however, in some embodiments, system interconnect 316 may be used to couple the memory control 314 to the decoder 306 and the processor cores 308 and 310.

In one embodiment, the platform 300 may communicate with various I/O devices via an I/O bus. Such I/O devices may include but are not limited to, for example, universal asynchronous receiver/transmitter (UART), USB 156, and I/O expansion interface or other I/O devices.

One embodiment of the platform 300 provides for mobile, network and/or wireless communications. The platform 300 may further include a memory 312. Memory 312 can be a dynamic random access memory (DRAM) device, a static random access memory (SRAM) device, flash memory device, or other memory device. Memory 312 can store instructions and/or data represented by data signals that can be executed by the processor 302. In one embodiment, memory 312 may comprise a system memory portion and a display memory portion. In another embodiment, the display memory may contain frame buffer to store memory surfaces (or GDL surfaces).

While FIG. 3 illustrates the display processor 308 and the graphics processor 310 and the decoder 306, in some embodiments, the processor 302 may comprise not comprise one or more of 308, 310 or 306. While FIG. 3 illustrates the display processor 308 and the graphics processor 310, some embodiments may utilize other display processing units and/or graphics processing units. While FIG. 3 illustrates audio control 318 and/or peripherals 320, in some embodiments, in some embodiments, the processor 302 may not comprise the audio control 318 and/or peripherals 320 in the processor 302. In another embodiment, processor 302 may comprise any other components such as transport processing units, security features such as security processor, interfaces and/or other peripherals.

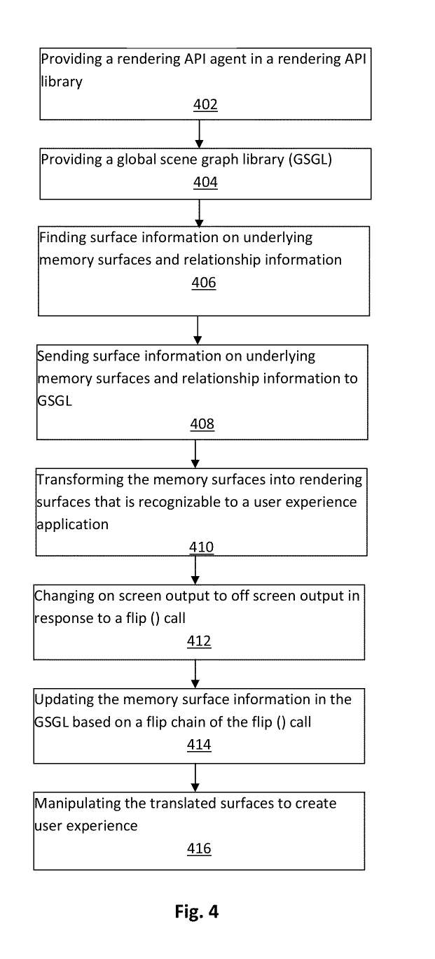

FIG. 4 illustrates an exemplary method according to an embodiment of the invention. Referring to FIGS. 1 and 4, in one embodiment, in block 402, a rending API agent such as 124 or 134 may be provided in a rendering API library 120 or 130. While FIG. 1 illustrates rendering API agents 124 and 134, in some embodiments, one or more rendering API agents may be provided in other native applications 140. The rendering API agent may comprise a rendering API wrapper. In block 404, a library may be provided under the user experience application 106. In one embodiment, the library may be a global scene graph library (GSGL) 110 that may be accessed by the rendering API libraries 120, 130 and 140 and the user experience application via the GDL driver 104 or any other interface. In another embodiment, the content of GSGL 110 may be stored in memory such as display memory. In an embodiment, the rendering API agent may communicate with GSGL 110.

In block 406, the rendering API agent may find a plurality underlying memory surfaces that correspond to a set of corresponding rendering surfaces allocated from the rendering API library. The rendering API agent may find other information such as relationship information between underlying memory surfaces and each process. In block 408, the rendering API agent send surface information on the underlying memory surfaces and the relationship information to GSGL 110. In another embodiment, the rendering API agent may further send relationship information between underlying memory surfaces and each process to GSGL 110.

In block 410, GSGL 110 may receive and record the surface information and the relationship information from the rendering API agent. In another embodiment, Binging library may utilize the surface information and the relationship information in GSGL 110 to transform the underlying memory surface to produce desired rendering API surfaces. In an embodiment, binding may be used for the translation, such as Clutter binding or any other binding such as OpenGL ES binding or DirectFB binding or the like. In one embodiment, the translated rendering API surfaces are recognizable to one or more user experience applications 106 or the corresponding underlying applications such as Clutter application 112.

In block 412, in response to a flip operation, the rendering API agent may intercept the flip ( ) calls and may notify the flip operation to GSGL 110. In an embodiment, the rendering API agent may further prohibit a real flip chain and may change the on screen output of the corresponding rendering API application to off screen. In block 414, GSGL 110 may update the surface information on the underlying memory surfaces according to the flip chain.

In block 416, the user experience application 106 may access GSGL 110 to obtain surface information on the underlying memory surfaces. Binging library may utilize the surface information and the relationship information in GSGL 110 to transform the underlying memory surface to desired rendering API surfaces. The user experience application 106 may manipulate the translated rendering surfaces (herein, rendering or memory) to create user experiences.

While the method of FIG. 4 is illustrated to comprise a sequence of processes, the method in some embodiments may perform illustrated processes in a different order. In some embodiments, the sequences of processes of FIG. 4 may be performed together with other processes (not shown). In one embodiment, block 410 may be executed after block 416.

While certain features of the invention have been described with reference to embodiments, the description is not intended to be construed in a limiting sense. Various modifications of the embodiments, as well as other embodiments of the invention, which are apparent to persons skilled in the art to which the invention pertains are deemed to lie within the spirit and scope of the invention.

1. A system, comprising:
a memory to store a graphics application and a user experience application;
a processor that is coupled to the memory, wherein the processor is to execute the graphics application to obtain a first rendering surface and a corresponding underlying memory surface, record surface information on the underlying memory surface and relationship information between the underlying memory surface and
a process of the graphics application, transform the underlying memory surface into a second rendering surface that is recognizable to the user experience application based on the recorded surface information and manipulate the second rendering surface to provide user experience.

2. The system of claim 1, wherein the processor is to record the surface information and the relationship information in a library that is accessible by the user experience application.

3. The system of claim 1, wherein the processor is to provide a global library under the user experience application to record the surface information and the relationship information, from the graphic application.

4. The system of claim 1, wherein the processor is to execute the user experience application based on an underlying graphics application, wherein the second rendering surface is recognizable to the underlying graphics application.

5. The system of claim 3, wherein the graphics application is provided in a rendering application programming interface (API) library.

6. The system of claim 5, wherein the processor is to provide a rendering API wrapper in the rendering API library, wherein the rendering API wrapper is to communicate with the global library to send the surface information and the relationship information to the global library.

7. A method, comprising:
providing a rending application programming interface (API) agent in a rendering API library;
providing a global library that is coupled with the rendering API agent;
sending to the global library surface information on a plurality of underlying memory surfaces that corresponding to a first set of rendering surfaces of the rendering API library and relationship information between the memory surfaces and a process of a corresponding rendering API application; and
transforming the memory surfaces into a second set of rendering surfaces that are recognizable by a user experience application.

8. The method of claim 7, further comprising:
manipulating the translated rendering surfaces to create a user interface for user experience.

9. The method of claim 7, further comprising:
changing on screen output of the rendering API application to off screen in response to a flip operation;
notifying the global library of the flip operation.

10. The method of claim 9, comprising:
updating the surface information in the global library in response to the flip operation.

11. A machine readable medium comprising a plurality of instructions that in response to being executed result in a computing device
providing a rending application programming interface (API) agent in a rendering API library;
providing a global library that is coupled with the rendering API agent;
sending to the global library surface information on a plurality of underlying memory surfaces that correspond to a first set of corresponding rendering surfaces of the API library and relationship information between the memory surfaces and a process of a corresponding rendering API application; and
recording the surface information and the relationship information in the global library.

12. The machine readable medium of claim 11, further comprising a plurality of instructions that in response to being executed result in a computing device
transforming the memory surfaces into a second set of rendering surfaces that are recognizable by a use experience application; and
manipulating the translated rendering surfaces to create a user interface for user experience.

13. The machine readable medium of claim 11, further comprising
a plurality of instructions that in response to being executed result in a computing device
changing on screen output of the rendering API application to off screen in response to a flip operation; notifying the global library of the flip operation.

14. The machine readable medium of claim 13, further comprising a plurality of instructions that in response to being executed result in a computing device
updating the surface information in the global library based on a flip chain in the flip operation.
